(19) United States
(12) Patent Application Publication
(10) Pub. No.: US 2004/0001490 A1
(43) Pub. Date: Jan. 1, 2004

(54) Method of verifying number of sessions of computer stack

(76) Inventor: Koji Shima, Kanagawa (JP)

Correspondence Address: FROMMER LAWRENCE & HAUG LLP, 745 FIFTH AVENUE, NEW YORK, NY, 10151, US

(21) Appl. No.: 10/418,232

(22) Filed: Apr. 17, 2003

(30) Foreign Application Priority Data
Apr. 19, 2002 (JP) 2002-118306

(51) Int. Cl. H04L 12/28

(52) U.S. Cl. 370/395.2; 370/395.52

(57) ABSTRACT

The number of sessions of a stack of a verification target machine is verified by connecting such verification target machine through a network with a verifier machine for verifying the number of sessions of the stack of the verification target machine; virtually generating an IP address to thereby produce at least one virtual machine in the verifier machine; and establishing a virtual session between the virtual machine and the verification target machine using a packet capture based on three-way handshake of TCP/IP. This enables advanced network verification on the software basis without needing expensive hardware.

This application is related to Japanese Patent Application No. 2002-118306 filed on Apr. 19, 2002, based on which this application claims priority under the Paris Convention and the contents of which are incorporated herein by reference.

### BACKGROUND OF THE INVENTION

1. Field of the Invention

The present invention relates to a method of verifying the number of sessions of a computer stack, a program to be executed by a computer for verifying the number of session of a stack, a computer-readable recording medium having recorded therein the program to be executed by a computer for verifying the number of sessions of a stack, and a system for verifying sessions of a stack.

2. Description of the Related Art

A large-scale computer such as server often establishes sessions with, for example, hundreds of thousands of client terminals on a network. From a viewpoint of ensuring reliability of the server, the server needs be preliminarily verified that to what extent of the number it can establish sessions with the client servers.

For example, verification of the number of sessions of a network stack such as a server needs a large number of computers to be procured as verifier machines. Assuming now that the server can establish five hundred thousands sessions, the verification requires the equivalent number of verifier machines, where procurement of such large number of machines only for the verification is not practical. The verification is disadvantageous also in needing rather expensive hardware for verifier machines, and a wide space for the verification. It is also anticipated that the machines per se could not bear the load when such a large number of sessions are to be verified.

As has been described in the above, verification of the number of the sessions of a stack requires a large number of expensive hardware and a wide space for the verification, which makes the verification of the number of sessions of a stack not practical also from the viewpoint of load on the machines to be verified.

### SUMMARY OF THE INVENTION

The present invention is completed in order to respond the foregoing need, and is to provide a method of verifying the number of sessions of a stack, a program to be executed by a computer for verifying the number of sessions of a stack, a computer-readable recording medium having recorded therein the program to be executed by a computer for verifying the number of sessions of a stack, and a system for verifying the number of sessions of a stack, where all of which are intended for making it unnecessary to procure a large number of expensive hardware, for reducing the space for the verification, and for solving the problem of the load on the machines.

A feature of the present invention resides in that a verification target machine is connected over a network with a verifier machine for verifying the number of sessions of a stack of the verification target machine, and in the verifier machine an IP address is virtually generated for a virtual machine to establish virtual sessions with the verification target machine based on three-way handshake of TCP/IP using a packet capture, thereby verifying the number of sessions of the stack of the verification target machine.

### BRIEF DESCRIPTION OF THE DRAWINGS

The above and other features will be better understood from the exemplary embodiments described below, taken together with the drawings, of which:

FIG. 1 is a diagram showing an exemplary constitution of a verification system in which a server and a client are connected through a hub as a line concentrator to a network;

FIG. 2 is a flow chart showing process steps for verifying the number of sessions;

FIG. 3 is a diagram showing an exemplary case in which three-way handshake is established by sending a SYN packet having, in the first virtual machine, a source port number of TCP of 1024;

FIG. 4 is a diagram showing an exemplary case in which three-way handshake is established by sending the next SYN packet having a source port number of 1025, which is incremented by 1 from 1024;

FIG. 5 is a diagram showing an exemplary case in which three-way handshake is established by sending the last SYN packet having a source port number of 65535;

FIG. 6 is a diagram showing an exemplary case in which three-way handshake is established by sending a SYN packet having, in the second virtual machine, a source port number of TCP of 1024;

FIG. 7 is a flowchart showing process steps for verifying the number of sessions which include a step for counting the number of sessions; and

FIG. 8 is a diagram showing an exemplary screen constitution of a GUI for verifying the number of sessions.

### DETAILED DESCRIPTION OF THE PREFERRED EMBODIMENTS

Preferred embodiments of the present invention are described in detail below, with references made to relevant accompanying drawings.

Outlines of Constitution of Verification System and Method for Verifying the Number of Sessions

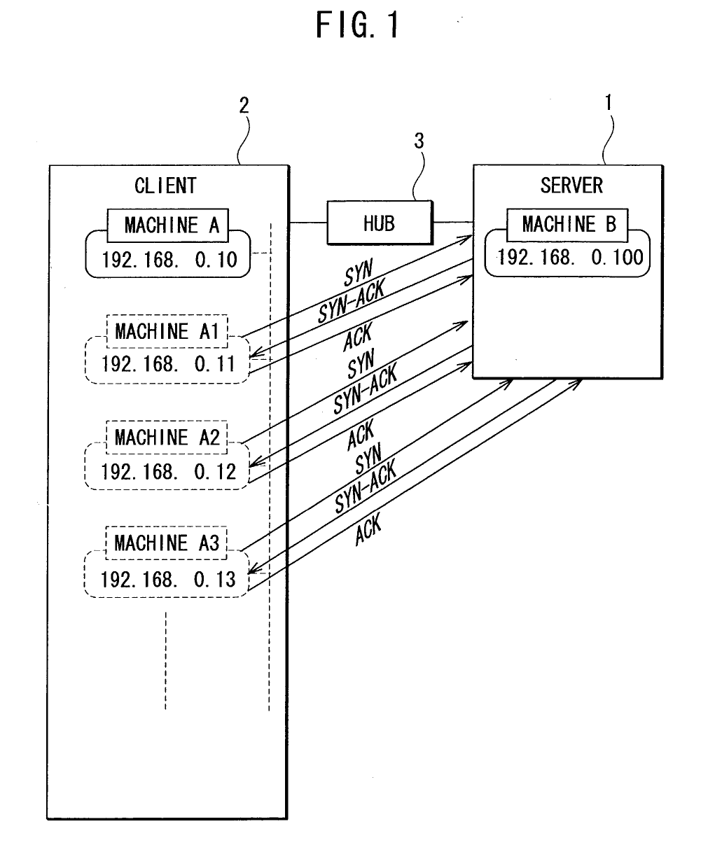

FIG. 1 shows an exemplary constitution of a verification system which comprises a server 1 working as a verification target machine on which a stack in need of verification is run, a client 2 working as a verifier machine, and a hub 3 working as a line concentrator through which the server 1 and the client 2 are connected on a network.

The server 1 is a real machine B, whose IP address is typically specified as “192.168.0.100”. Similarly, also the client 2 is a real machine “A”, whose IP address is typically specified as “192.168.0.10”.

In this embodiment, as will be described in later, virtual IP addresses are generated in the real machine “A” by a program for verifying the number of sessions of a stack according to the present invention to thereby produce virtual machines A1, A2, A3 . . . by a number necessary for verifying the number of sessions of a stack in the machine B. This allows the client 2 to exist in the network as if it has, besides the real machine “A”, a group of plurality of virtual machines comprising the virtual machines A1, A2, A3 . . . .

In the present embodiment, virtual three-way handshake sessions of TCP/IP (Transmission Control Protocol/Internet Protocol) are established between a group of virtual machines A1, A2, A3 . . . virtually produced in the real machine “A” and a stack run on the machine B which is a verification target machine, to thereby verify the number of sessions of the stack on the machine B.

More specifically, according to the program for verifying the number of sessions of a stack according to the present invention, a virtual machine group comprising a plurality of virtual machines A1, A2, A3 . . . are produced in the real machine “A” as shown in FIG. 1, a virtual session is then established between the first virtual machine Al in the virtual machine group and the machine B based on three-way handshake, and the similar virtual sessions are further established thereafter in a sequential manner, such as those established between the next virtual machine A2 and the machine B, between the further next virtual machine A3 and the machine B, and so on.

In a specific procedure for establishing a virtual session based on three-way handshake, the virtual machine A1 sends a SYN packet, which is a connection establishment request, to the machine B. More precisely, the real machine “A” sends the SYN packet to the machine B while assuming the virtual machine A1 as a sender. Establishment of the three-way handshake is confirmed when the machine “A” receives from the machine B a response to the foregoing SYN packet and a SYN-ACK packet (a packet having both flags of SYN and ACK) , which is a connection establishment request directed to the virtual machine A1; and when the virtual machine A1 (the real machine “A” in practice) then sends to the machine B an ACK packet, which is a confirmation response to the SYN-ACK packet. As described in the above, the present invention is successful in verifying the number of sessions of the stack on the machine B solely based on the send-receive operations of the packets between the virtual machine A1 and machine B.

Establishment of a session is confirmed as successful if the three-way handshake was successful based on correct send-receive operations of the individual packets between the virtual machine A1 and machine “B” as shown in FIG. 1, but confirmed as unsuccessful if the three-way handshake was unsuccessful due to interruption of the send-receive operations of these packets.

As described in the above, in order to establish the three-way handshake between any of the virtual machines A1, A2, A3 virtually produced in the real machine “A” and the machine B which is a verification target machine, it is necessary to use a packet capture capable of capturing a packet flowing on the network directed to an arbitrary machine even if the packet is not directed to the own machine. In the general network, a machine is generally set so as not to receive any flowing packets which are not directed to such machine, but using the packet capture allows the machine to receive such packet not directed thereto.

Verification of Sessions

Next paragraphs will describe the method of verifying the number of sessions of the stack on the machine B, which is a verification target machine, using the verification system previously shown in FIG. 1. In the present embodiment, sessions are established between the first virtual machine A1 and a stack run on the machine B while changing the port number of the TCP source port (Src Port) of the first virtual machine A1 from 1024 to 1025 (1024+1), 1026 (1025+1) and so on in a one-by-one incremental manner finally up to 65535. Sessions are then similarly established also between the virtual machine A2 having the next IP address and the stack run on the machine B, and established also between the further next virtual machine A3 and the stack run on the machine B, while individually changing the source port number of TCP source port from 1024 to 65535, to thereby verify the number of sessions.

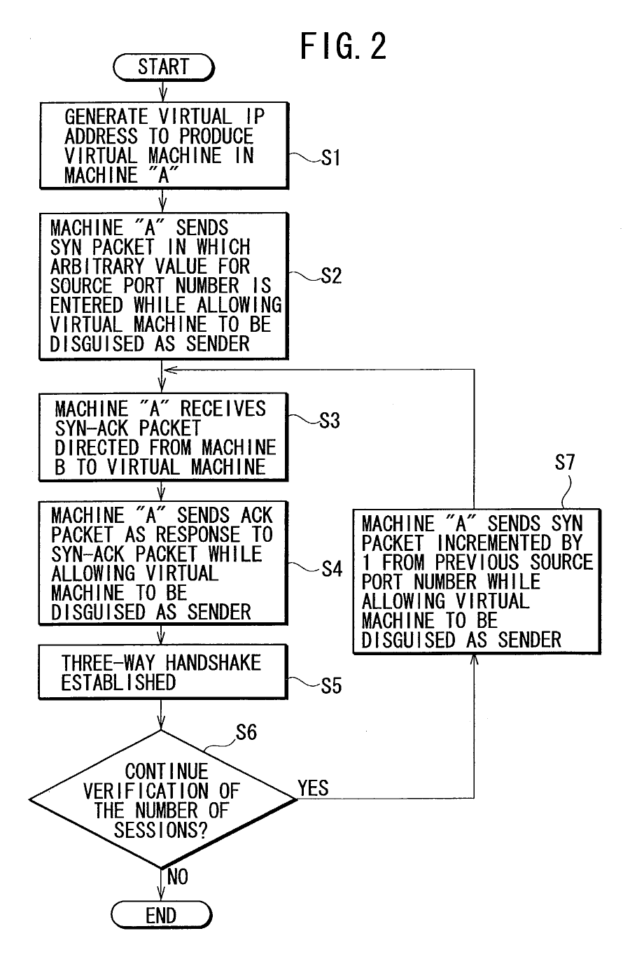

FIG. 2 is a flowchart showing process steps for verifying the number of sessions using the program for verifying the number of sessions of a stack according to the present invention. The process steps shown in FIG. 2 are carried out by a control section of the machine “A” operated based on the program for verifying the number of sessions of a stack according to the present invention.

The process step for verifying the number of sessions shown in FIG. 2 starts when the program for verifying the number of sessions according to the present invention is run on the real machine “A”. In step S1, virtual IP addresses are generated on the machine “A”, which is a verifier machine, to thereby produce the virtual machines A1, A2, A3 . . . . In an exemplary case shown in FIG. 1, the first virtual machine A1 has an IP address of “192.168.0.11”, the second virtual machine A2 has an IP address of “192.168.0.12”, and the third virtual machine A3 has an IP address of “192.168.0.13”.

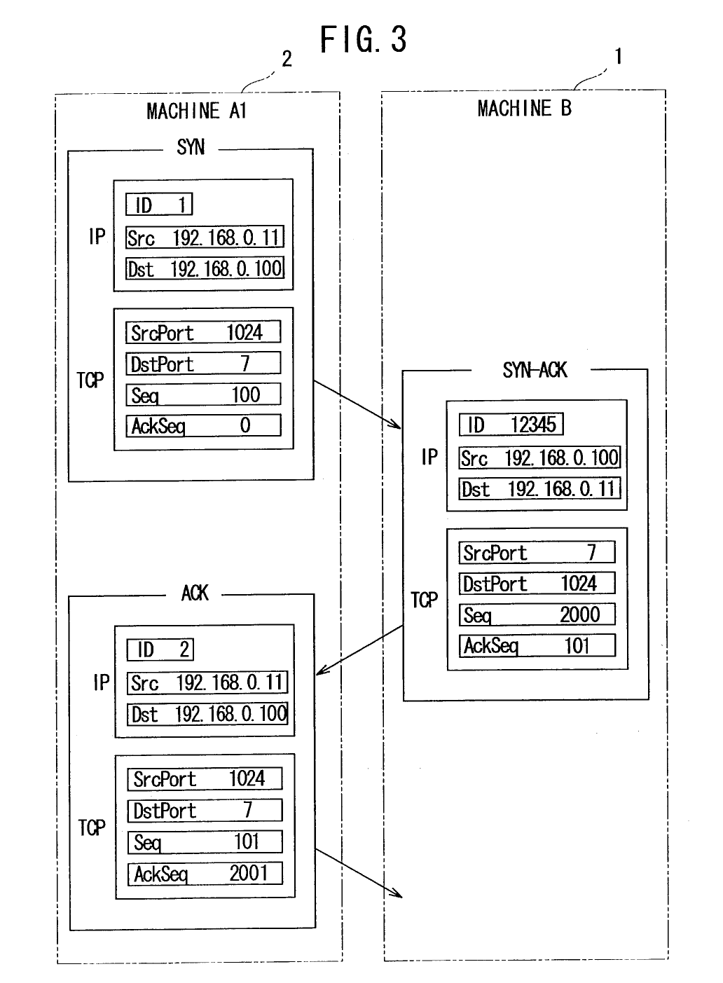

Next in step S2, a SYN packet is generated, which is used for sending, from the first virtual machine A1 to the target machine B to be verified, a packet which is equivalent to a connection establishment request. The SYN packet generated herein typically comprises, as shown in FIG. 3, an IP header and a TCP header, where the IP header includes an ID of “1”, a source address (Src) of “192.168.0.11” which is an IP address of this virtual machine A1, and a destination address (Dst) of “192.168.0.100” which is an IP address of the machine B; and the TCP header includes a source port number of “1024”, a destination port number of “7” which is a port number of the machine B, a sequence number (Seq) of “100” which is an initial value for the virtual machine A1 itself, and a confirmation acknowledge number (AckSeq) of “0”.

According to the processing in step S2, the real machine “A” sends thus-produced SYN packet to the machine B, while assuming the virtual machine Al as a sender. In other words, the virtual machine A1 actually does not send the SYN packet to the machine B, but the real machine “A” disguises itself as the virtual machine A1 so as to send the SYN packet to the machine B.

It is to be noted that arrows in FIG. 3 represent travel of the packets, where the packets are sent in the direction pointed by the arrows.

Upon reception of the SYN packet, the machine B returns to the virtual machine A1 a SYN-ACK packet as an acknowledgement and connection establishment request. The SYN-ACK packet generated herein typically comprises, as shown in FIG. 3, an IP header and a TCP header, where the IP header includes an ID of “12345”, a source address (Src) of “192.168.0.100” which is an IP address of the machine B, and a destination address (Dst) of “192.1-68.0.11” which is an IP address of the virtual machine A1; and the TCP header includes a source port number of “7” which is a port number of the machine B, a destination port number of “1024” which is a port number of the machine A1, a sequence number (Seq) of “2000” which is an initial value for the machine B itself, and a confirmation acknowledge number (AckSeq) of “101” which is equivalent to the foregoing sequence number “100” incremented by 1.

Next in the process of step S3, the real machine “A” receives the SYN-ACK packet which was sent by the machine B towards the virtual machine A1. While the SYN-ACK packet directed from the machine B to the imaginary virtual machine A1 cannot generally be received by the machine “A”, using the packet capture allows the real machine “A” to receive the SYN-ACK packet sent to the virtual machine A1. When the machine “A” receives the SYN-ACK packet directed to the virtual machine A1 in step S3, the process for verifying the number of sessions advances to step S4.

In the process of step S4, the machine “A” already received the SYN-ACK packet directed to the virtual machine A1 sends an ACK packet to the machine B in response to the SYN-ACK packet while disguising itself as the virtual machine A1. That is, the machine “A” sends the ACK packet to the machine B in response to the SYN-ACK packet assuming the virtual machine A1 as a sender.

The ACK packet comprises, as shown in FIG. 3, an IP header and a TCP header, where the IP header includes an ID of “2”, a source address (Src) of “192.168.0.11” which is an IP address of the virtual machine A1, and a destination address (Dst) of “192.168.0.100” which is an IP address of the machine B; and the TCP header includes a source port number of “1024” which is a port number of the virtual machine A1, a destination port number of “7” which is a port number of the machine B, a sequence number (Seq) of “101”, and a confirmation acknowledge number (AckSeq) of “2001” which was generated by adding 1 to the sequence number of 2000.

When the ACK packet is sent from the machine “A” to machine B, it is recognized in step S5 that three-way handshake was established. Based on the establishment of the three-way handshake, it is determined that a session was established between the virtual machine A1 having a source port number of 1024 and the machine B, where the number of sessions is counted as 1.

On the contrary, a case where three-way handshake could not be established, it is recognized that a session was not established between the virtual machine A1 and machine B. Three-way handshake will not be successful possibly when the SYN-ACK packet does not reach the real machine “A” (for the case where the SYN packet reached the machine B but not recognized by the machine B), or when the machine B again returns the SYN-ACK packet to the machine “A” although the ACK packet was already sent to the machine B (for the case where the ACK packet cannot be recognized by the machine B although it has already reached the machine B). Failure in establishing three-way handshake is determined when the SYN and ACK packets can not be successfully sent or received after not only once but even a predetermined number of times of send/receive operation of such packets.

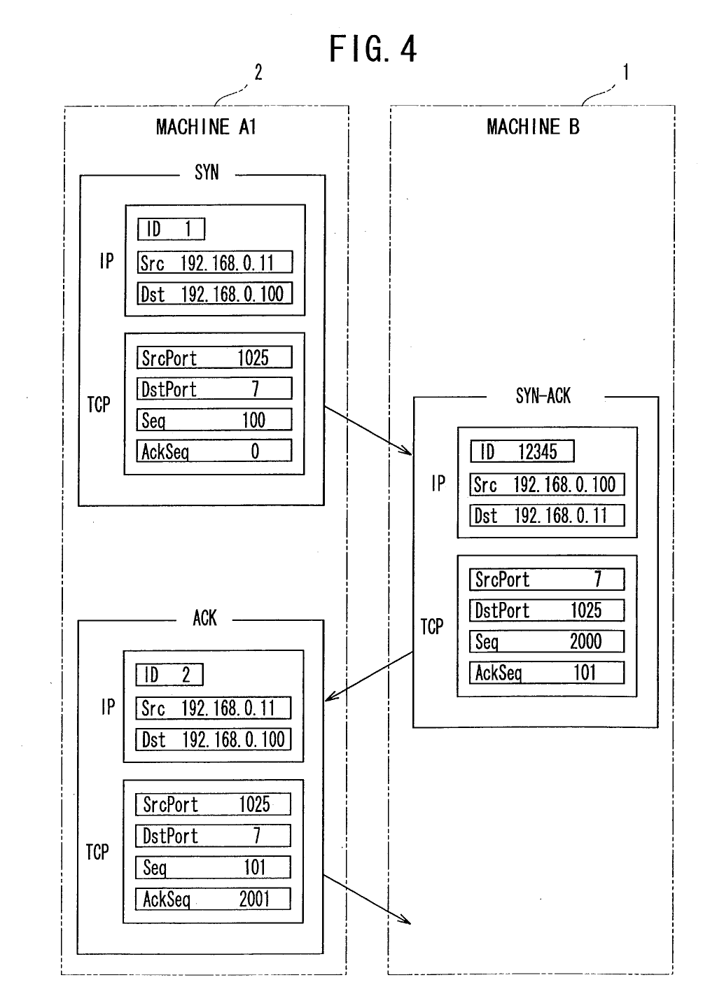

If it was confirmed next in the process of step S6 that the verification of the number of sessions is to be continued, the process for verifying the number of sessions advances to step S7, but the process comes to the end if the verification of the number of sessions is to be terminated. For the case the verification of the number of sessions is to be continued, the machine “A” then sends in step S7, as shown in FIG. 4, a SYN packet having a port number of 1025, which is incremented by 1 from the source port number (Src Port) 1024 of TCP of the SYN packet which was sent at first. While the port number of the SYN packet sent herein has been incremented by 1 from source port number of TCP in the SYN packet which was sent at first, the IP header and TCP header remain the same with those of the SYN packet which was sent at first. In short, the machine “A” in step S7 sends to the machine B a SYN packet having a port number incremented by 1 from that of the SYN packet which was already sent at first (that is, a SYN packet differs from the SYN packet already sent at first only in the source port number of TCP).

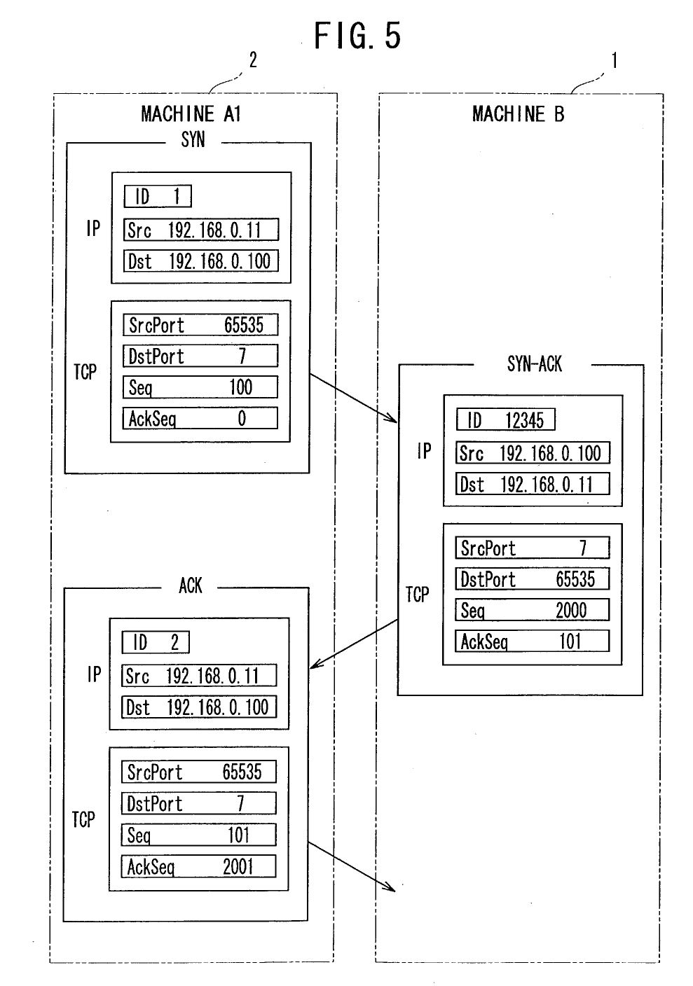

Thereafter the process for verifying the number of sessions repeats steps S3 through S7. In this embodiment, the first virtual machine A1 is verified while changing the source port number of TCP from 1024, which is then sequentially incremented by 1 so as to obtain 1025 (1024+1) , 1026(1025+1) and so on and up to 65535 (65534+1). FIG. 5 shows exemplary headers of the SYN packet, SYN-ACK packet and ACK packet for the case where the source port number is 65535.

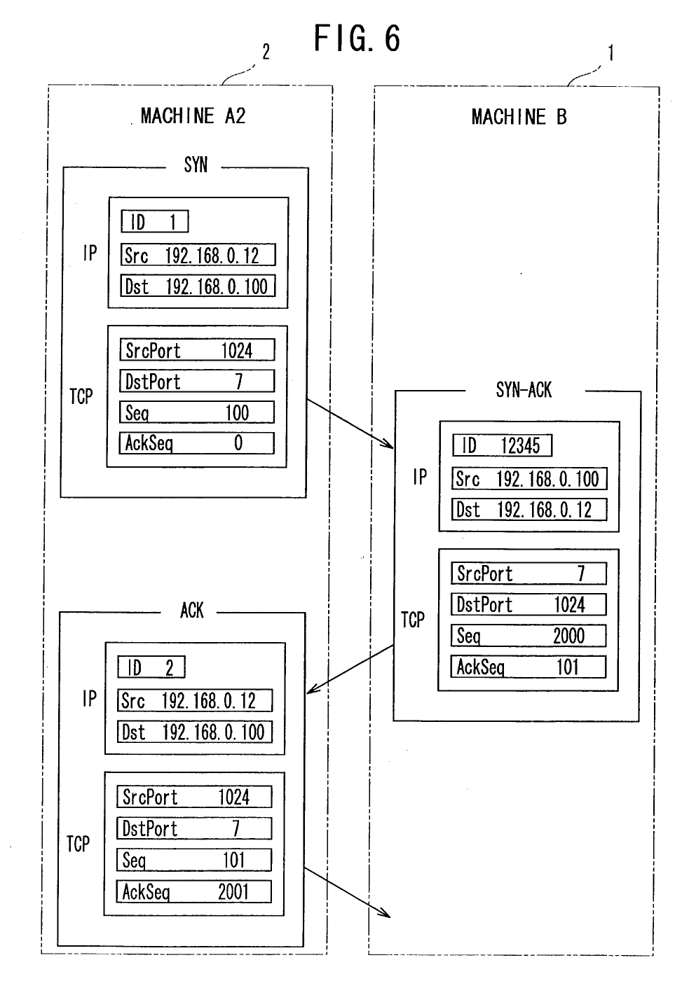

Upon completion of the verification of the number of sessions between the first virtual machine A1 and machine B while changing the source port number of TCP from 1024 to 65535, sessions are then verified also between the machine B and each of second virtual machine A2, third virtual machine A3, . . . and so on. FIG. 6 shows an exemplary verification of sessions between the second virtual machine A2 and machine B. In this case, only one difference resides in that the second virtual machine A2 has a source address of IP of “192.168.0.12”, where the IP and TCP headers remain the same with those of the first virtual machine A1.

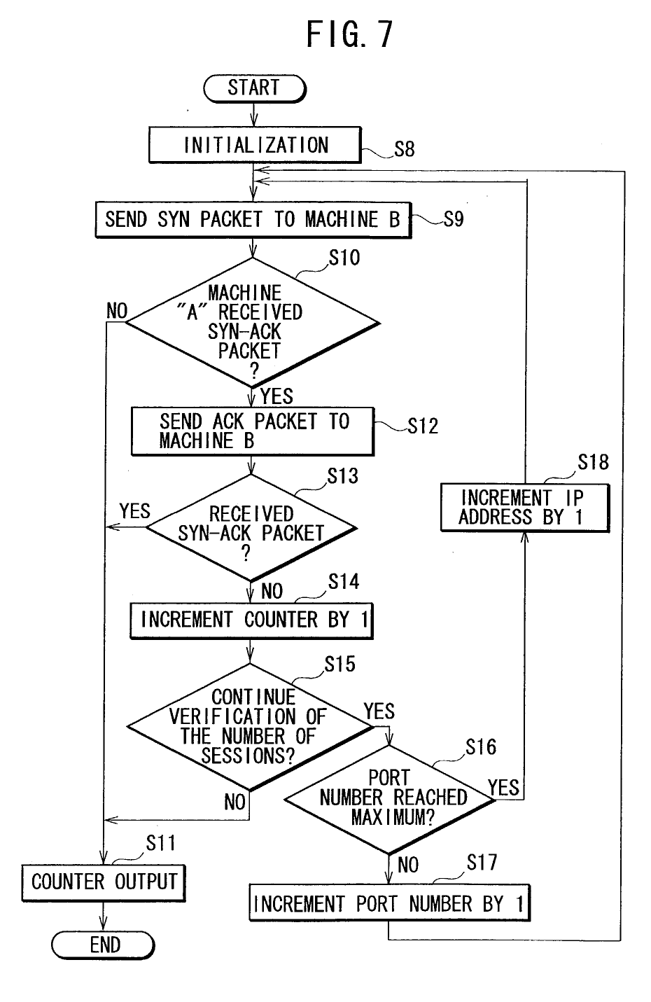

Next paragraphs will describe an entire process including the step for counting the number of sessions referring to the flow chart shown in FIG. 7. The description will brief send/receive operation of the packets, and instead a stress will be placed on counting of the number of sessions.

The process described hereafter is to verify whether sessions can actually be established up to a maximum number of sessions which is specified for the stack of the machine B. Assuming now that the machine B is designed to allow sessions up to a maximum number of 300, 000 for example, whether the sessions can really be established up to that maximum number or not is verified in the process steps described below.

First in the process of step S8, the machines “A” is initialized. In the initialization, a virtual IP address (e.g., 192.168.0.11) is generated for the machine “A” to thereby produce an initial (first) virtual machine A1, and at the same time sets a counter for counting the number of sessions to zero, and sets the port number to an initial value (e.g., 1024). Next in the process of step S9, the machine “A” sends a SYN packet to the machine B while changing the source address thereof to that of the virtual machine A1. If it was determined in step S10 that the machine “A” has not received the SYN-ACK packet directed to the virtual machine A1, the process for verifying the number of sessions advances to step S1, whereat a counter value equivalent to the maximum number of sessions ever established is output.

On the other hand, if the machine “A” was determined to have received the SYN-ACK packet directed to the virtual machine A1, the process for verifying the number of sessions advances to step S12, where the machine “A” sends to the machine B an ACK packet while changing the source address thereof to that of the virtual machine A1. If it was determined in step S13 that the machine “A” received the SYN-ACK packet again although the ACK packet has been sent, the process advances to step S11 whereat a counter value equivalent to the number of sessions ever established is output. On the contrary, if the machine “A” was determined to have not received the SYN-ACK packet, the process for verifying the number of sessions advances to step S14, whereat the counter value is incremented by 1 assuming that a session has been established between the virtual machine A1 and machine B.

If it was determined in the next step S15 that the verification of the number of sessions is to be continued, the process for verifying the number of sessions advances to step S16, and if the verification is to be terminated, the process advances to step S11, whereat a counter value equivalent to the maximum number of sessions ever established is output and is also displayed on a display portion, which completes the process for verifying the number of sessions. For the case where the sessions were successfully established up to the maximum number, the maximum number of sessions of the stack of the machine B will be displayed on the display portion. Whether the maximum source port number (65535 in the above-described example) has been reached or not is then determined in step S16, and if NO, the process for verifying the number of sessions then advances to step S17.

In the process of step S17, the source port number (e.g., 1024) of the SYN packet that was sent at first is incremented by 1. On the other hand, if the source port number was determined in step S16 to be equivalent to the maximum number, the process advances to the step S18, whereat the virtual IP address (e.g., 192.168.0.11) is incremented by 1 so as to produce a new virtual machine, and at the same time the source port number is reset to thereby recover the initial value (e.g., 1024). Since the new virtual IP address is preliminarily designed so as to be captured, the process for verifying the number of sessions repeats the foregoing step S9 and there after upon completion of step S17 or S18.

Sessions are thus sequentially established while incrementing the source port number one by one between the virtual machine A1 and machine B, and once the source port number reached maximum, the virtual IP address is then incremented by 1 so as to establish sessions between thus incremented virtual machine A2 and machine B. This process is repeated until a predetermined maximum number of sessions is reached. If the three-way handshake cannot be established during the process, a maximum number of sessions ever established at that point of time is output.

For instance, if sessions are successful in establishing sessions up to a predetermined maximum number (three hundred thousands), the stack of the machine B is verified that it can afford three hundred thousands sessions. On the other hand, if both of the virtual machines A1 and A2 are successful in establishing sessions for the source port numbers from 1024 through 65535 and the next virtual machine A3 fails in establishing a session for a source port number of 1025, the total number of successful sessions will be 129025 (64512 ×2+1) . The maximum number of the sessions of the stack of the machine B can thus be verified as 129025.

As is known from the above, by using the program for verifying the number of sessions of a stack according to the present invention, the above-described SYN packet is freely generated on the text basis, sent from the machine “A”, while disguising itself as a virtual machine, to the machine B; the SYN-ACK packet, which is a response to such SYN packet and a connection establishment request, directed to the virtual machine is received by the machine “A”; and the ACK packet, which is a response to the SYN-ACK packet, is sent to the machine B. It is to be noted now that the verification can be carried out not only on the text basis but also on the GUI (graphic user interface) basis.

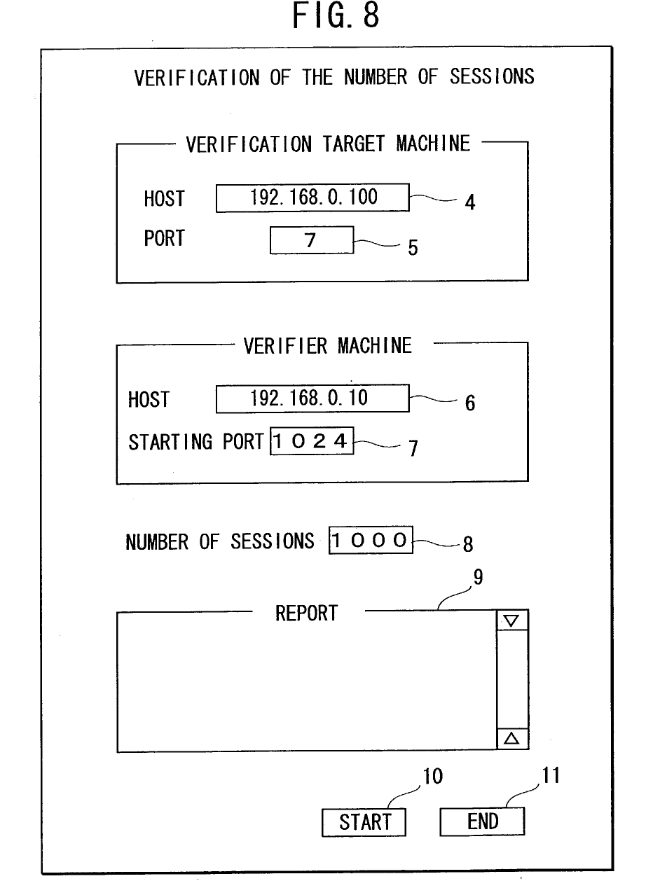

FIG. 8 shows an exemplary constitution of a GUI screen for verifying the number of sessions. The GUI screen comprises a source address entering box 4 where a source address of a verification target machine (machine B) is entered; a port number entering box 5 where a port number is entered; a source address entering box 6 where a source address of the verifier machine (an address for the actual machine) is entered; a starting port entering box 7 where a starting port number is entered; a session number entering box 8 where an upper limit of the number of sessions to be verified is entered; a report box 9 where whether sessions are successfully established or not or how many sessions are established, is recorded; a start button 10 for starting verification of the number of sessions; and an end button 11 for terminating verification of the number of sessions. Using such GUI allows anybody to readily verify the number of sessions of a stack of a verification target machine.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

For example, while the above embodiment dealt with the case where the port numbers are first altered so as to establish sessions and the IP addresses are then altered so as to establish sessions, order of such alterations may be inverted. More specifically, it is also allowable to first alter the IP addresses so as to establish sessions between each of the virtual machines A1, A2, A3 . . . and the machine B, and then alter the port numbers of the individual virtual machines A1, A2, A3 . . . so as to again establish sessions with the machine B.

While the above embodiment dealt with the case where the ID and sequence number (Seq) of the SYN packet are fixed unchanged, it is also allowable to alter them. For example, ID1 maybe followed by ID11 , ID21 and so on, and the sequence numbers may be such as 100, 200, 300 . . . and so on. In this case, the ID of the ACK packet will automatically change to ID2, ID12, ID22 and so on, and the sequence number will also change to 101, 201, 301 and so on. “Increment of ten (+10)”from ID 1 to 11, or “increment of 100 (+100)”from sequence number 100 to 200 may also be adjustable.

According to the present invention, a virtual IP address is generated on a verifier machine so as to produce at least one virtual machine, and a virtual session is established between such virtual machine and a verification target machine using a packet capture based on three-way handshake of TCP/IP, which allows verification of the number of sessions of a stack of the verification target machine using only a single verifier machine without need of procuring a plurality of expensive hardware.

Since the number of sessions of a stack of a verification target machine can be verified with the aid of software using only a single verifier machine, the present invention is advantageous in needing no wide space for the verification. The verification on the software basis is also beneficial in saving cost for the verification to a large extent as compared with that required in a verification method using an expensive set of hardware.

What is claimed is:

1. A method of verifying a number of sessions of a stack comprising the steps of:
connecting a verification target machine through a network to a verifier machine for verifying the number of sessions of the stack of the verification target machine;
virtually generating an IP address to produce at least one virtual machine in the verifier machine; and
establishing a virtual session between the virtual machine and the verification target machine using a packet capture based on three-way handshake of TCP/IP.

2. The method of verifying a number of sessions of a stack according to claim 1, wherein the virtual session is established when the virtual machine sends a SYN packet to the verification target machine; the virtual machine receives a SYN-ACK packet as a response to the SYN packet and as a connection establishment request from the verification target machine; and the virtual machine sends an ACK packet as a response to the SYN-ACK packet to the verification target machine.

3. The method of verifying a number of sessions of a stack according to claim 2, further comprising a step of:
altering, each time the SYN packet is sent, a value of an arbitrary header of at least either of TCP and IP in the SYN packet to be sent from the virtual machine to the verification target machine.

4. The method of verifying a number of sessions of a stack according to claim 3, wherein the header altered each time the SYN packet is sent is a source port number of the TCP, which is incremented by 1 from the value of the previously-sent source port number.

5. The method of verifying a number of sessions of a stack according to claim 3, wherein the header altered each time the SYN packet is sent is a source address of the IP, which is incremented by 1 from the value of the previously-sent source address.

6. A computer-readable recording medium having recorded therein a program for verifying a number of sessions of a stack, which is to be executed on a computer,
the program comprising the steps of:
connecting a verification target machine through a network to a verifier machine for verifying the number of sessions of the stack of the verification target machine;
virtually generating an IP address to produce at least one virtual machine in the verifier machine; and
establishing a virtual session between the virtual machine and the verification target machine using a packet capture based on three-way handshake of TCP/IP.

7. A system for verifying a number of sessions of a stack comprising:
a verification target machine;
a verifier machine for verifying the number of sessions of the stack of the verification target machine, connected through a network to the verification target machine;
a generator for virtually generating an IP address to produce at least one virtual machine on the verifier machine; and
an establishing unit for establishing a virtual session between the virtual machine and the verification target machine using a packet capture based on three-way handshake of TCP/IP.

8. A program for verifying a number of sessions of a stack, which is to be executed on a computer, comprising the steps of:
connecting a verification target machine through a network to a verifier machine for verifying the number of sessions of the stack of the verification target machine;
virtually generating an IP address to produce at least one virtual machine in the verifier machine; and
establishing a virtual session between the virtual machine and the verification target machine using a packet capture based on three-way handshake of TCP/IP.
